(19) United States
(12) Patent Application Publication
(10) Pub. No.: US 2024/0383272 A1
(43) Pub. Date: Nov. 21, 2024

(54) Decorative Doorbell Cover Device

(71) Applicant: Micah Myers, Roseville, OH (US)

(72) Inventor: Micah Myers, Roseville, OH (US)

(21) Appl. No.: 18/470,470

(22) Filed: Sep. 20, 2023

Related U.S. Application Data
(60) Provisional application No. 63/466,423, filed on May 15, 2023.

(51) Int. Cl. B44C 1/18; G08B 3/10

(52) U.S. Cl. CPC B44C 1/18; G08B 3/10

(57) ABSTRACT

A decorative doorbell cover device is provided. The device is primarily comprised of a body, preferably made of silicone that can be placed around a smart doorbell to change the appearance of the doorbell. The body may have the general appearance of any theme, image, character, color, item, food, etc., in which a user desires. The body is further comprised of a first opening and a second opening to allow the camera and the button of the smart doorbell to be unobstructed when the device is attached to the doorbell.

### CROSS-REFERENCE TO RELATED APPLICATION

The present application claims priority to, and the benefit of, U.S. Provisional Application No. 63/466,423, which was filed on May 15, 2023, and is incorporated herein by reference in its entirety.

### FIELD OF THE INVENTION

The present invention relates generally to the field of doorbells. More specifically, the present invention relates to a decorative doorbell cover device that can be placed around a smart doorbell to change the appearance of the doorbell. The body may have the general appearance of any theme, image, character, color, item, food, etc., in which a user desires. Accordingly, the present disclosure makes specific reference thereto. Nonetheless, it is to be appreciated that aspects of the present invention are also equally applicable to other like applications, devices, and methods of manufacture.

### BACKGROUND

Many individuals have a smart doorbell at a doorway into their home. However, some individuals may not enjoy the visual appearance of a smart doorbell. Unfortunately, the only way to change the appearance of a smart doorbell is to purchase a different smart doorbell of another aesthetic appearance.

Therefore, there exists a long-felt need in the art for a device that allows a user to change the appearance of a smart doorbell. There also exists a long-felt need in the art for a decorative doorbell cover device that can be applied over an existing smart doorbell to change the appearance of the doorbell. In addition, there exists a long-felt need in the art for a decorative doorbell cover device that can be applied over an existing smart doorbell to change the appearance of the doorbell and wherein the device can resemble any character, theme, item, etc., the user desires.

The subject matter disclosed and claimed herein, in one embodiment thereof, comprises a decorative doorbell cover device. The device is comprised of a body preferably made of silicone that can be placed around a smart doorbell to change the appearance of the doorbell. The body may have the general appearance of any theme, image, character, color, item, food, etc., in which a user desires. The body is further comprised of a first opening and a second opening to allow a camera and a button of the smart doorbell to be unobstructed when the device is attached around the doorbell.

In this manner, the decorative doorbell cover device of the present invention accomplishes all of the foregoing objectives and provides a device that allows a user to change the appearance of a smart doorbell. More specifically, the decorative doorbell cover device can be applied over any existing smart doorbell known in the art to change the appearance of the smart doorbell. Furthermore, the decorative doorbell cover device can be applied to any smart doorbell to change the appearance of the doorbell into any character, theme, item, etc., in which the user desires.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a decorative doorbell cover device primarily comprised of a body, a first opening, and a second opening. The device is designed to be placed over a smart doorbell to change the appearance of the smart doorbell to any character, image, theme, likeness, color, shape, etc., that a user desires.

The device is comprised of a generally rectangular body made of a flexible, waterproof plastic or rubber material. The body may further resemble any shape, image, color, likeness, object, etc. In differing embodiments, the body of the device may be shaped to fit into themes, such as, but not limited to, a holiday, a season, a show, a game, etc.

The body is further comprised of a top surface, a side surface, and a rear surface. The top surface is comprised of a first opening and a second opening allowing for a camera and a button of the smart doorbell to be unobstructed when the device is attached to the doorbell. The side surface may provide additional protection to the doorbell. The rear surface may act as a lip around the rear surface of the doorbell to secure the device to the doorbell. In one potential embodiment, the rear surface is comprised of at least one fastener to further secure the device to/around the doorbell.

The present invention is also comprised of a method of using the device. First, a device is provided comprised of a body, a first opening, and a second opening. Then, the device may be stretched over a smart doorbell so that the device fits snugly around the surface of the doorbell. Then, the first opening is aligned with the camera of the smart doorbell to give the camera an unobstructed view. Next, the second opening is aligned with the button of the smart doorbell to make the button visible to a user.

The present invention is also comprised of a method of using the device. First, a device is provided comprised of a body, a first opening, and a second opening. Then, the device may be stretched over the smart doorbell so that the device fits snugly around the surface of the doorbell. Then, a fastener of the rear surface of the device may be attached to the smart doorbell to secure the device to the doorbell. Next, the first opening is aligned with the camera of the smart doorbell to give the camera an unobstructed view. Then, the second opening is aligned with the button of the smart doorbell to make the button visible to a user.

Accordingly, the decorative doorbell cover device of the present invention is particularly advantageous, as it provides a device that allows a user to change the appearance of a smart doorbell. More specifically, the decorative doorbell cover device can be applied to any smart doorbell known in the art while maintaining access to the button and not obstructing the view of the camera of the doorbell. Furthermore, the decorative doorbell cover device can change the appearance of any smart doorbell into any character, theme, color, item, object, etc., in which the user desires. In this manner, the decorative doorbell cover device provides an aesthetically pleasing doorbell cover.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded view of one potential embodiment of a decorative doorbell cover device and a smart doorbell of the present invention in accordance with the disclosed architecture;

FIG. 2 illustrates a front view of one potential embodiment of a decorative doorbell cover device of the present invention while covering a smart doorbell in accordance with the disclosed architecture;

FIG. 3 illustrates a rear view of one potential embodiment of a decorative doorbell cover device of the present invention while covering a smart doorbell in accordance with the disclosed architecture;

FIG. 4 illustrates a flowchart of a method of using one potential embodiment of a decorative doorbell cover device of the present invention in accordance with the disclosed architecture; and

FIG. 5 illustrates a flowchart of a method of using one potential embodiment of a decorative doorbell cover device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all of the aspects or advantages shown. Thus, in other embodiments, any of the features described herein from different embodiments may be combined.

As noted above, there is a long-felt need in the art for a device that allows a user to change the appearance of a smart doorbell. There also exists a long-felt need in the art for a decorative doorbell cover device that can be applied over an existing smart doorbell to change the appearance of the doorbell. In addition, there exists a long-felt need in the art for a decorative doorbell cover device that can be applied over an existing smart doorbell to change the appearance of the doorbell and wherein the device can resemble any character, theme, item, etc., the user desires.

The present invention, in one exemplary embodiment, is comprised of a decorative doorbell cover device. The device is primarily comprised of a body, a first opening, and a second opening. The device is designed to be placed over a smart doorbell to change the appearance of the smart doorbell to any character, image, theme, likeness, color, shape, etc., that a user desires.

More specifically, the device is comprised of a generally rectangular body that is preferably made of a flexible plastic or rubber material. While the body is generally rectangular, the body may resemble any shape to fit any theme. In differing embodiments, the body of the device may be shaped into different holiday décor items for various holidays such as Christmas, Valentine's Day, the Fourth of July, Halloween, etc. The body may also resemble seasonal themes for the spring, summer, fall, and winter.

The body is further comprised of three surfaces: a top surface, a side surface, and a rear surface. The top surface of the body is further comprised of a first opening and a second opening. The first opening allows for the camera of the smart doorbell to be unobstructed when the device is in use. The second opening allows for a button of the smart doorbell to be unobstructed when the device is in use. The side surfaces of the body of the device may cover the sides of the smart doorbell and add a layer of protection to the smart doorbell as well. The rear surface of the body is generally in the form of a lip that extends onto the rear surface of the doorbell but does not cover the entire rear surface of the doorbell, allowing the device to be easily applied to and removed from a smart doorbell. In one potential embodiment, the rear surface of the body may also be comprised of an at least one fastener that further secures the device to the smart doorbell.

The present invention is also comprised of a method of using the device. First, a device is provided comprised of a body, a first opening, and a second opening. Then, the device may be stretched over the smart doorbell so that the device fits snugly onto the surface of the doorbell. Then, the first opening is aligned with the camera of the smart doorbell to give the camera an unobstructed view. Next, the second opening is aligned with the button of the smart doorbell to make the button visible to a user.

The present invention is also comprised of a method of using the device. First, a device is provided comprised of a body, a first opening, and a second opening. Then, the device may be stretched over the smart doorbell so that the device fits snugly onto the surface of the doorbell. Then, a fastener of the rear surface of the device may be attached to the smart doorbell to secure the device to the doorbell. Next, the first opening is aligned with the camera of the smart doorbell to give the camera an unobstructed view. Then, the second opening is aligned with the button of the smart doorbell to make the button visible to a user.

Accordingly, the decorative doorbell cover device of the present invention is particularly advantageous as it provides a device that allows a user to change the appearance of a smart doorbell. More specifically, the decorative doorbell cover device can be applied to any smart doorbell known in the art while maintaining access to a button and not obstructing the view of a camera of the doorbell. Furthermore, the decorative doorbell cover device can change the appearance of any smart doorbell into any character, theme, color, item, object, etc., in which the user desires. In this manner, the decorative doorbell cover device provides an aesthetically pleasing doorbell cover.

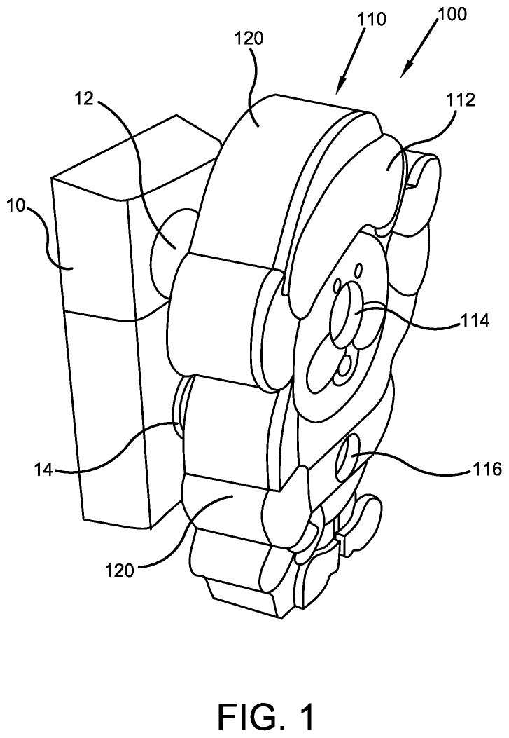

Referring initially to the drawings, FIG. 1 illustrates an exploded view of one potential embodiment of a decorative doorbell cover device 100 and a smart doorbell 10 of the present invention, in accordance with the disclosed architecture. The device 100 is primarily comprised of a body 110, a first opening 114, and a second opening 116. The device 100 is designed to be placed over/around a smart doorbell 10 to change the appearance of the smart doorbell 10 to any character, image, theme, likeness, color, shape, etc., that a user desires.

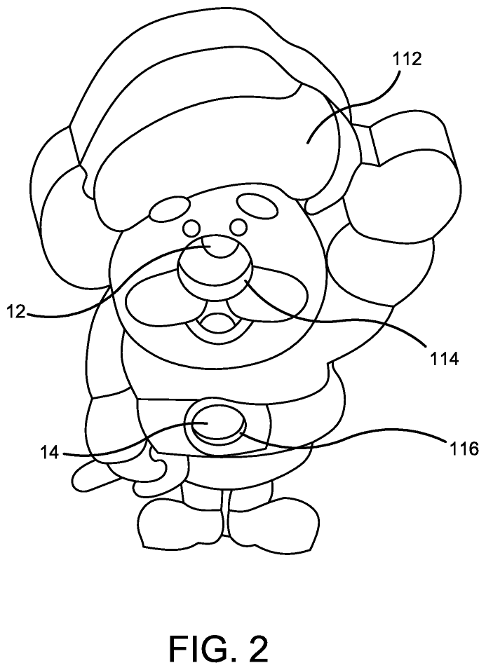

FIG. 2 illustrates a front view of one potential embodiment of a decorative doorbell cover device 100 of the present invention, while covering a smart doorbell 10 in accordance with the disclosed architecture. The body 110 is preferably made of a silicone material but may be made of any flexible rubber or plastic material that is waterproof and that can be stretched to fit snugly around the doorbell 10. The body 110 is generally rectangular but may take the appearance of many shapes, characters, foods, people, colors, items, objects, animals, etc. in differing embodiments. For example, a user may desire a holiday-themed device 100 that could have the general appearance of a Santa Claus, a present, a snowflake, a reindeer, etc., for Christmas; a heart, a bow and arrow, a rose, etc. for Valentine's Day; an American flag, a firework, may be colored red, white and blue, etc., for the Fourth of July; a black cat, a witch, a ghost, a goblin, a spider, etc., for Halloween; or any other image that can be associated with a holiday. Further, a user may want a seasonally themed device 100 that could have the general appearance of a flower, a butterfly, an umbrella, etc., for spring; a sunset, a beach, a sprinkler, a pool, etc., for summer; a leaf, a pumpkin, a fire, etc., for autumn; or a snowflake, a snowman, an ice-skating rink, etc., for winter. In addition, the device 100 may have the general appearance of movie and TV characters, board games, furniture, food, or any general image in which a user desires.

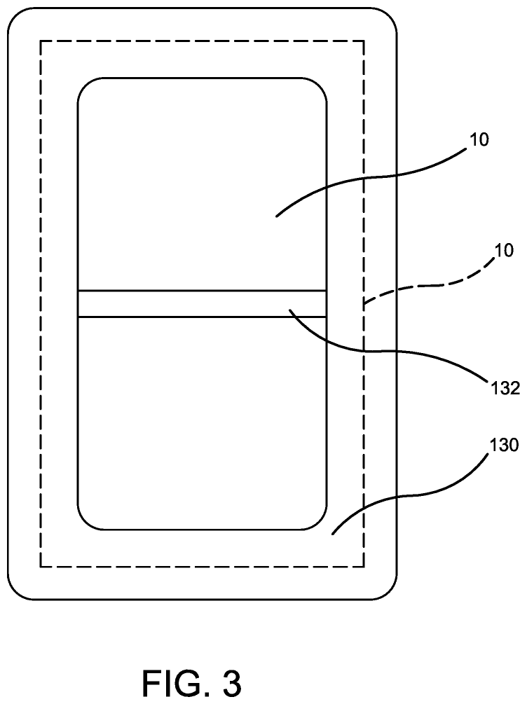

FIG. 3 illustrates a rear view of one potential embodiment of a decorative doorbell cover device 100 of the present invention while covering a smart doorbell 10 in accordance with the disclosed architecture. The body 110 is further comprised of three surfaces: a top surface 112, a side surface 120, and a rear surface 130. The top surface 112 is comprised of a first opening 114 and a second opening 116. In differing embodiments, the top surface 112 may be comprised of additional openings to accommodate smart doorbells 10 that may have multiple cameras, multiple buttons, or other features of the like. The first opening 114 allows for the camera 12 of the smart doorbell 10 to be unobstructed when the device 100 is attached to the doorbell 10. The second opening 116 allows for the button 14 of a smart doorbell 10 to be unobstructed when the device 100 is attached to the doorbell 10.

The side surfaces 120 of the body 110 may cover the sides of the smart doorbell 10 and add an extra layer of protection for the doorbell 10 from any potential falling debris during storms. The rear surface 130 of the body 110 is generally in the form of a lip that extends onto the rear surface of the doorbell 10 allowing the device to be easily attached to the doorbell 10 as well as removed from the doorbell 10.

In one potential embodiment of the device 100, the rear surface 130 of the body 110 may be comprised of at least one fastener 132 that further secures the device 100 to the doorbell 10. In this embodiment, the fastener 132 may be any fastener known in the art, such as, but not limited to, a hook-and-loop fastener, an elastic band, a magnet, an adhesive, etc.

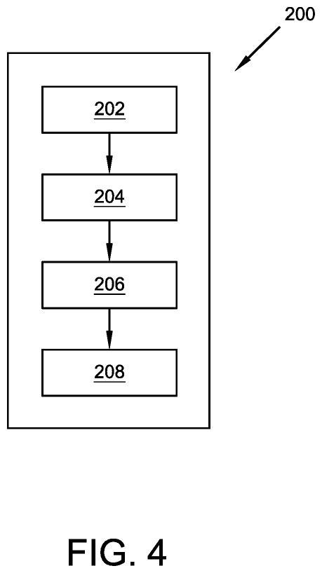

The present invention is also comprised of a method 200 of using the device 100, as seen in FIG. 4. First, a device 100 is provided comprised of a body 110, a first opening 114, and a second opening 116 [Step 202]. Then, the device 100 may be stretched over the smart doorbell 10 so that the device 100 fits snugly onto/around the surface of the doorbell 10 [Step 204]. Then, the first opening 114 is aligned with the camera 12 of the smart doorbell 10 to give the camera 12 an unobstructed view [Step 206]. Next, the second opening 116 is aligned with the button 14 of the smart doorbell 10 to make the button 13 visible to a user to be easily pressed [Step 208].

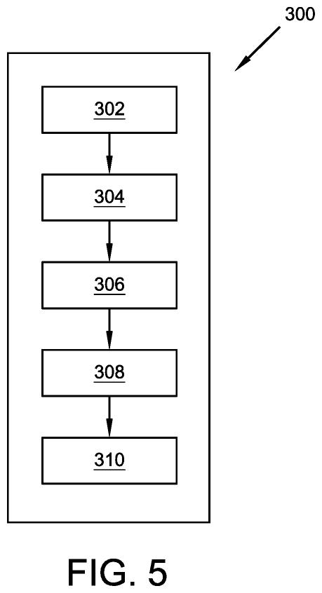

The present invention is also comprised of a second method 300 of using the device 100, as seen in FIG. 5. First, a device 100 is provided comprised of a body 110, a first opening 114, and a second opening 116 [Step 302]. Then, the device 100 may be stretched over the smart doorbell 10 so that the device 100 fits snugly onto/around the surface of the doorbell 10 [Step 304]. Then, a fastener 132 of the rear surface 130 of the device 100 may be attached to/around the smart doorbell 10 to secure the device 100 to the doorbell 10 [Step 306]. Next, the first opening 114 is aligned with the camera 12 of the smart doorbell 10 to give the camera 12 an unobstructed view [Step 308]. Then, the second opening 116 is aligned with the button 14 of the smart doorbell 10 to make the button 13 visible to a user to be easily pressed [Step 310].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “decorative doorbell cover device” and “device” are interchangeable and refer to the decorative doorbell cover device 100 of the present invention.

Notwithstanding the foregoing, the decorative doorbell cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the decorative doorbell cover device 100 as shown in the FIGS. are for illustrative purposes only, and that many other sizes and shapes of the decorative doorbell cover device 100 are well within the scope of the present disclosure. Although the dimensions of the decorative doorbell cover device 100 are important design parameters for user convenience, the decorative doorbell cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A decorative doorbell cover device comprising:
a body comprised of a top surface and a side surface;
a first opening; and
a second opening.

2. The decorative doorbell cover device of claim 1, wherein the body is comprised of a waterproof material.

3. The decorative doorbell cover of claim 1, wherein the body is comprised of a flexible material.

4. The decorative doorbell cover device of claim 3, wherein the flexible material is comprised of a silicone.

5. The decorative doorbell cover device of claim 1, wherein the body resembles a character, an image, a theme, a likeness, a color, a shape, a food, a person, an item, an object, or an animal.

6. The decorative doorbell cover device of claim 1, wherein the first opening is positioned on the top surface.

7. The decorative doorbell cover device of claim 1, wherein the second opening is positioned on the top surface.

8. A decorative doorbell cover device comprising:
a body comprised of a top surface, a rear surface, and a side surface;
a first opening;
a second opening; and
a fastener positioned on the rear surface.

9. The decorative doorbell cover device of claim 8, wherein the body is comprised of a waterproof material.

10. The decorative doorbell cover device of claim 9, wherein the waterproof material is comprised of a silicone.

11. The decorative doorbell cover device of claim 8, wherein the body is comprised of a rigid material.

12. The decorative doorbell cover device of claim 8, wherein the body resembles a character, an image, a theme, a likeness, a color, a shape, a food, a person, an item, an object, or an animal.

13. The decorative doorbell cover device of claim 8, wherein the first opening is positioned on the top surface.

14. The decorative doorbell cover device of claim 8, wherein the second opening is positioned on the top surface.

15. The decorative doorbell cover device of claim 8, wherein the fastener is comprised of a hook and loop fastener, an elastic fastener, a magnet fastener, or an adhesive fastener.

16. The decorative doorbell cover device of claim 8, wherein the rear surface is comprised of a lip.

17. A method of using a decorative doorbell cover device, the method comprising the following steps:
providing a decorative doorbell cover device comprised of a body comprised of a first opening and a second opening;
stretching the device over a smart doorbell;
aligning the first opening with a camera of the smart doorbell; and
aligning the second opening with a button of the smart doorbell.

18. The method of claim 17, wherein a rear surface of the body is comprised of a fastener.

19. The method of claim 18 further comprised of a step of attaching the fastener to or around the smart doorbell.

20. The method of claim 18, wherein the fastener is comprised of a hook and loop fastener, an elastic fastener, a magnet fastener, or an adhesive fastener.
